(19) United States
(12) Patent Application Publication
(10) Pub. No.: US 2003/0133619 A1
(43) Pub. Date: Jul. 17, 2003

(54) System for handling multiple discrete cosine transform modes and method thereof

(76) Inventors: Daniel W. Wong, Thornhill (CA); Milivoje Aleksic, Richmond Hill (CA); Wayne Y.J. Wu, Brampton (CA); William Hui, Markham (CA)

Correspondence Address: TOLER & LARSON & ABEL L.L.P., PO BOX 29567, AUSTIN, TX, 78755-9567, US

(21) Appl. No.: 10/052,053

(22) Filed: Jan. 17, 2002

(51) Int. Cl. G06K 9/36

(52) U.S. Cl. 382/248

(57) ABSTRACT

A system and methods are described for processing image data related to both 8-8 image data, corresponding to a single 8×8 image data set, and 2-4-8 image data, corresponding to two related 4×8 image data sets associated with different fields of an 8×8 image block. The image data is received and processed using separate discrete cosine transform (DCT) matrices. An 8-8 matrix processes the 8-8 image data and a 2-4-8 matrix processes the 2-4-8 image data. The matrices are used to generate forward DCT results when accessed in a normal fashion. The matrices are transposed through a column-major accessing scheme to generate inverse DCT results.

### FIELD OF THE DISCLOSURE

The present invention relates generally to processing video and more particularly to processing motion compensation error data.

### BACKGROUND

Digital video is generally processed in sets of video frames. Each frame is a still image representing an instant in time of the video being processed. These frames include a large amount of data that must be transmitted to a display device. In order to facilitate transmission, each frame is further broken down into blocks relating to 8×8 picture elements. The blocks are individually transmitted and then recombined to form a frame for display. The amount of data needed to represent these image blocks may still be quite large however, so motion compensation is sometimes used to reduce the amount of data needed to represent the image blocks.

Using motion compensation, image blocks can be represented by motion compensation vectors and error data. Motion compensation vectors are used in prediction frames, also known as “P-frames”. P-frames allow an object in one frame to simply be repositioned in a new frame. Accordingly, the image blocks used to represent the object in the new frame may be processed with motion vectors, using the image blocks in the original frame as reference. The motion vectors provide the direction and distance in which the referenced image blocks have moved in the new, or predicted, frame.

In some cases, motion compensation vectors are all that are needed to reproduce an image block; however, in many situations, some other differences exist between the reference image block and the block in the predicted frame. Error data can be used to recover the differences, and adequately generate the image block. The error data itself is basic image information, including the luminance of the pixels within the image block. A transform, such as a discrete cosine transform (DCT), can reduce the amount of error data in a transformed data set. This transformed data set includes transfer coefficients which can be inverse transformed to reproduce the error data.

In some cases, no motion vectors can be generated for a given image block. For example, when a video switches to a completely new scene, none of the objects in the new frame can be referenced to objects in the previous frame. In such a case, the image block is represented only with error data. Furthermore, some reference frames for motion compensation are made up of image blocks represented with only error data. These reference frames including only error data are referred to as intra-frames, or I-frames. The P-frames are motion compensated frames that use previous I- or P-frames for reference.

In addition to P-frames and I-frames, bi-directional frames (B-frames) may be used in handling image data. Bi-directional frames use previous or upcoming I- or P-frames for reference. It should be noted that B-frames are never used as reference themselves to avoid the accumulation of precision errors.

Digital video decoding hardware is used to process the error data and motion compensation vectors into video frame data. To generate the video frame data the motion compensation vector data and the error data are captured. The transformed error data sets are inverse transformed, such as through an inverse discrete cosine transform (IDCT) component, to reproduce the error data. In conventional systems, 8×8 blocks of transformed error data are sent to be inverse transformed one at a time. The conventional video decoding hardware uses an 8-8 IDCT component to reproduce a block of error data.

To facilitate error data processing of image data containing interlaced video, separate fields may be sent separately for processing. Two 4×8 sets of transformed error data are sent to hardware for processing into an 8×8 block of error data. Each 4×8 set is generally unique to a field of a video frame. To inverse transform the two 4×8 (2-4-8) sets of transformed error data into an 8×8 block of error data, conventional systems use separate hardware components for processing the 8×8 transformed error data.

Conventional video encoding/decoding systems must implement separate components for handling processing for 8-8 versus 2-4-8 data and for transforming and inverse transforming data. Implementing separate components is costly and reduces the amount of space available for implementing other hardware components. From the above discussion it is apparent that a method and system with improved efficiency for transforming and inverse transforming video data would be useful.

### BRIEF DESCRIPTION OF THE DRAWINGS

Specific embodiments of the present invention are shown and described in the drawings presented herein. Various objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, and wherein:

FIG. 1 is a block diagram illustrating a system for processing video data, according to one embodiment of the present invention;

FIG. 2 is a block diagram illustrating components of a system for processing multiple forms of image data, according to one embodiment of the present invention;

FIG. 3 is a flow diagram illustrating a method of processing multiple forms of image data, according to one embodiment of the present invention; and

FIG. 4 is a block diagram illustrating a pipeline for calculating forward and inverse discrete cosine transforms on a set of image data using a single matrix structure, according to one embodiment of the present invention.

### DETAILED DESCRIPTION OF THE FIGS

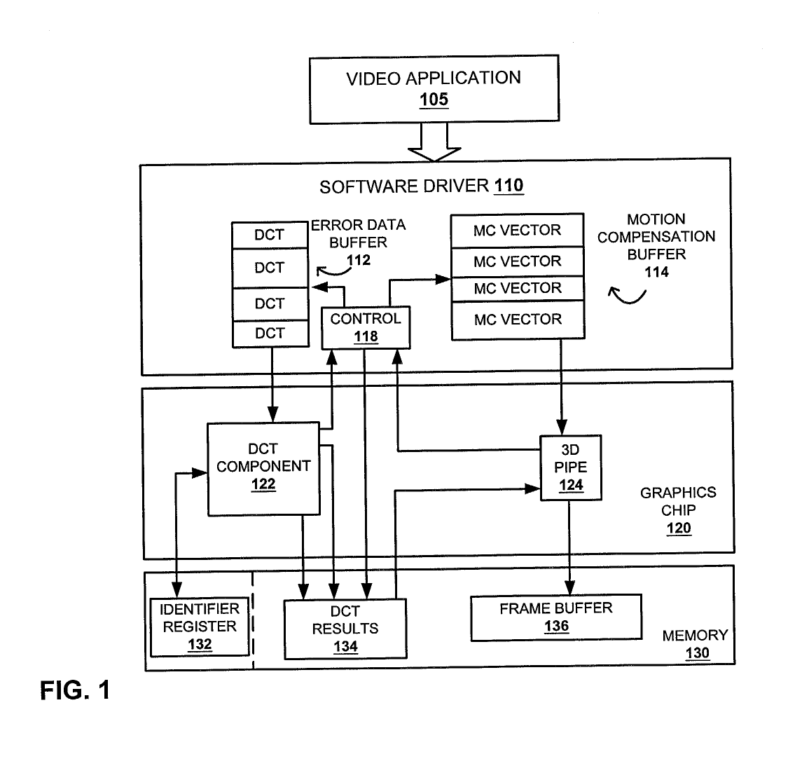

Referring now to FIG. 1, a block diagram illustrating a system for processing video data is shown, according to one embodiment of the present invention. A video application 105 generates video data. A software driver 105 stores error data associated with the video data in error data buffer 112. The stored error data is passed to a discrete cosine transform (DCT) engine, such as DCT component 122. In one embodiment, the stored error data includes raw image data that may be used to generate a video frame. In one embodiment, transformed error data associated with a forward discrete cosine transform (FDCT) is processed by DCT component 122 using an inverse discrete cosine transform (IDCT) and stored in DCT results 134 of memory 130. Alternatively, non-transformed error data is processed by DCT component 122 using an FDCT. In one embodiment, DCT component 122 is further capable of processing error data associated with both an 8-8 block of image data and a 2-4-8 block of image data.

Video application 105 can include video applications such as digital video disk (DVD) player software, a digital television tuner, an application programming interface (API), a video capture application, or video encoding or decoding software. In one embodiment, when using motion compensation techniques to display video images, video information related to a new block of image data within a frame of video is temporal-wise compressed using motion compensation (MC) vectors. In temporal-wise compression, blocks in a new frame are compared to blocks in a reference frame. Objects in the reference frame may simply move or be displaced in the new frame. Therefore, an MC vector, indicating the direction and distance an object in a reference frame has moved, can be used to describe where the blocks representing the object should be in a new frame. MC vectors may not always be enough to represent the block in the new, or predicted, frame. Differences between the block in the reference frame and the block in the new frame are transmitted as error data.

Error data is generally image data, including pixel information to reproduce any image information not covered using MC vectors. The error data can be compressed using a DCT. The DCT is a discrete orthogonal transformation between a time and frequency domain. Generally an FDCT is performed on the error data to generate transformed error data coefficients, allowing an IDCT to later be used on the transformed error data coefficients to restore the error data from the DCT results. The error data can correct for any image information left out using the MC vectors. It should be noted that some blocks, even in predicted frames, may be sent using only transformed error data, without any corresponding MC vectors.

Error and MC data can be received through video application 105. Video application 105 can be an application programming interface (API), or a device driver interface (DDI), such as a DirectX Video Acceleration API/DDI. The video data, error data and MC vector data received by video application 105, are sent to a software driver, such as software driver 110. As previously discussed, in one embodiment, video application 105 includes video encoding software. Accordingly, video application 105 may generate non-transformed error data to be processed into transformed error data through DCT 122. Alternatively, video application 105 may include video decoding software in which video application 105 may provide transformed error data to be inverse transformed by an IDCT transform of DCT 122.

Software driver 110 receives the video data provided through video application 105. Error data is stored in an error data buffer 112. MC vector data is stored in MC buffer 114. A control 118 is used to monitor requests from graphics chip 120. When components 122 and 124 have completed processing a set of data, interrupts are sent to software driver 110, through control 118, indicating components 122 and 124 are ready to receive new data. In one embodiment, identifiers indicating a portion of a video to which a particular set of error data corresponds is sent to DCT component 122 with the set of error data, to allow processed error data to be matched with MC vector data for processing.

Once error data with a particular identifier is received by DCT component 122, the identifier is stored in an identifier register 132. When the error data is processed through DCT component 122, an interrupt indicating the particular identifier is sent to control 118. Software driver 110 can use the reported identifier to send corresponding MC vector data from MC buffer 114. In one embodiment, software driver 110 sends all the sets of MC vector data in MC buffer 114 until it finds the set of MC vector data associated with the identifier. Alternatively, a semaphore may be used to track the error data processed from error data buffers 112 and MC vector data stored in MC buffer 115.

Graphics chip 120 includes components for processing video data from software driver 110. A DCT component 122 is used to process error data. In one embodiment, software driver 110 sends the error data. In another embodiment, the error data is read from memory 130 by DCT component 122. In one embodiment, DCT component 122 includes a DCT reader for receiving the error data, a DCT core for processing the error data and a DCT writer for storing the results from the DCT core. The DCT results may be stored in memory 130, such as in DCT results 134. DCT component 122 uses different DCT matrices for processing error data received as either 8-8 image data or as 2-4-8 image data. The DCT matrices are used to perform an FDCT on untransformed error data.

To process error data associated with transformed error data, the matrices are transposed, allowing an IDCT to be performed. The same DCT matrix is used in FDCT and IDCT operations; however, the DCT matrix is accessed differently to achieve a transposed DCT matrix for performing IDCT operations. In one embodiment, the transpose is performed by DCT component 122 by switching from a row-major access of the matrices to a column-major access of the matrices. For example, to perform an FDCT on 8-8 image data, DCT component 122 performs matrix multiplication on an 8×8 matrix formed by the 8-8 image data and a row-major accessed 8-8 DCT matrix. To perform an IDCT on 8-8 transformed image data, DCT component 122 performs matrix multiplication on an 8×8 matrix formed by the 8-8 transformed image data and a column-major accessed 8-8 DCT matrix. Similarly, a set of 2-4-8 matrices is used for processing 2-4-8 image data sets. DCT component 122 stores the results of the processed image data in DCT results 134, of memory 130.

In one embodiment, MC vector data sets stored in MC buffer 114, corresponding to the processed DCT data stored in DCT results 134, are sent by software driver 110 to a motion compensation processing component, such as 3D pipe 124. In one embodiment, 3D pipe 124 receives a memory address with the MC vector data sets to indicate where to read the error data, stored in DCT results 134, related to the MC vector data sets. Alternatively, error data from DCT component 122 is sent to 3D pipe 124. 3D pipe 124 processes the MC vector data along with the corresponding error data to generate a complete set of image data. Sets of image data corresponding to inverse transformed data can be stored in frame buffer 136. Frame buffer 136 can be represented by a location in memory 130 or in hardware, such as in graphics chip 120. Alternatively, the set of image data can be delivered to a display device (not shown). Sets of image data corresponding transformed data may be stored in memory 130 or output to an alternate set of video processing hardware (not shown). In one embodiment, a prediction plane is obtained based on the motion compensation vector data and a reference frame. The prediction plane may be combined with error data to produce the final image blocks.

Once 3D pipe 124 has read the error data stored in DCT results 134, 3D pipe 124 can send a second interrupt to control 118 in software driver 110. The second interrupt instructs software driver 110 that the data in DCT results 134 has been read. Software driver 110 can then free the memory space associated with DCT results 134 and send more error data from DCT buffer 112 to DCT component 122. This allows DCT results 134 to be filled with new error data, while 3D pipe 124 is busy processing the received image data. Software driver 110 can also use the second interrupt to determine whether to send any completed image frames or portions of image frames from frame buffer 136 to a display device (not shown).

In one embodiment, all data sent between software driver 110 and graphics chip 120 is encoded or scrambled to protect the video content represented. For example, the error data sent to DCT component 122 and the motion compensation vector data sent to 3D pipe 124 is scrambled by software driver 110. Accordingly, graphics chip 120 would de-scramble the content, through a de-scrambling component (not shown), before the content is processed by respective components.

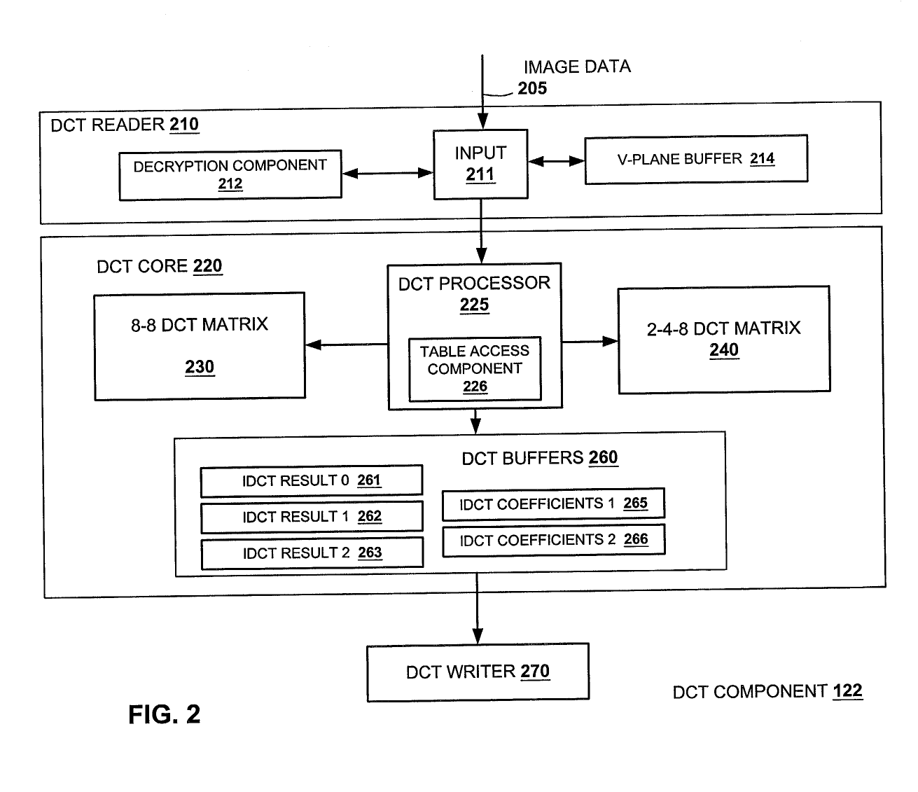

Referring now to FIG. 2, a block diagram illustrating components of a system for processing multiple forms of image data is shown, and is referenced generally as DCT component 122, according to one embodiment of the present invention. Image data 205 is read and processed through a transform engine, such as DCT component 122. Image data 205 is used to refer to raw image data that may result from error data processed through motion compensation. DCT component 122 includes a DCT reader 210 for receiving and preparing image data 205. Prepared image data is processed through DCT core 220. DCT core 220 applies a DCT or IDCT matrix to process the prepared image data. DCT core 220 is capable of performing both inverse and forward DCT processing. Accordingly, wither transformed or inverse transformed image data may be presented to input 211 for processing, depending on a particular mode of operation. Processed image data is passed to DCT writer 270, which stores the processed image data in memory (not shown). DCT reader 210, DCT core 220 and DCT writer 270 work together to allow DCT component 122 to read image data and store transformed, or inverse transformed, results in memory.

Input 211 of DCT reader 210 reads image data 205 from memory or an image data buffer, such as image data buffer 112 (FIG. 1). In one embodiment, DCT reader 210 supplies an address of memory to access image data 205. In another embodiment, DCT reader 210 sends a request for image data 205 from a buffer. For example, DCT reader 210 may generate an interrupt to software driver 110 (FIG. 1), requesting more image data from image data buffer 112 (FIG. 1). Input 211 may include pointers to the image data buffer or portion of memory from which image data 205 is to be read.

In one embodiment, image data 205, corresponding to transformed image data, may be encrypted. DCT reader 210 may use decryption component 212 to decrypt image data 205 prior to processing through DCT core 220. Image data 205 may be encrypted using a dynamic encryption key, wherein the dynamic encryption key value changes during transmission. Accordingly, DCT reader 210 may need to synchronize to a source device which is encrypting the data. In one embodiment, input 211 synchronizes to software driver 110 for decrypting image data 205. As previously discussed, identifiers may also be sent with image data 205, indicating a portion of an image frame to which they correspond. An interrupt is generated indicating, to a software driver, the corresponding MC vector data which needs to be sent, allowing related image data and MC vector data to be processed together in a separate component, such as 3D pipe 124 (FIG. 1). Input 211 maintains synchronization of the current portion of an image frame being processed through the identifiers.

In one embodiment, image data corresponding to U- and V-plane image data is sent together. Image data is broken down into Y, U, and V data. The Y data refers to a luminance, or intensity, associated with a source image. The U and V data represent chrominance, or color, planes associated with the source image. Since the human eye is more sensitive to changes of intensity than color, more luminance data is sent than U and V data for every image macroblock of a video frame being encoded. The U- and V-plane data is generally sent together as UV image data. To properly process the chrominance data, the U and V data must be separated prior to processing by DCT core 220. Input 211 stores the V-plane image data in a V-plane buffer 214. The U-plane data is then sent to DCT core 220. Once the U-plane data is processed, the V-plane data from V-plane buffer 214 is sent to DCT core 220.

In one embodiment, image data 205, corresponding to transformed image data, is run-level encoded. A block of image data may be composed of several zeros with few non-zero values. To compress the image data, run-level coding sends the non-zero values with information regarding the number of zeros between subsequent non-zero values. For image data 205 to be processed correctly by DCT core 220, input 211 decodes run-level coded image data into a proper image data block for processing through DCT processor 225 of DCT core 220. It should be appreciated that other encoding and decoding algorithms may be used for compressing and decompressing the image data. For example, Huffman coding may be used to break down the image data into code words received and decoded by input 211. Alternatively, the image data may be compressed through block truncation coding. Other techniques of encoding and decoding the image data may be used without departing from the scope of the present invention.

In one embodiment, end-of-block (EOB) instructions are embedded in image data 205, where the image data corresponds to transformed image data. The EOB instructions are used by input 211 to indicate when a block of data ends. Input 211 responds to the EOB instruction by applying zeros to the remaining portion of the received data block not received. In one embodiment, if a faulty transmission/reception of image data 205 causes an EOB instruction to not be received by input 211, DCT component 122 may become hung-up waiting for more image data. Accordingly, input 211 may complete incomplete blocks of image data when no EOB instruction is sent for a specified period of time.

As previously discussed, the image data may relate to non-transformed image data, which is to be processed with a DCT, such as through DCT processor 225. The image data may also relate to transformed error data, which is to be processed through an IDCT, through DCT processor 225. Input 211 notifies table access component 226 of DCT processor 225 with the type of processing (DCT or IDCT) to be performed. In one embodiment, input 211 identifies the type of processing to be performed through an indicator sent with image data 205. Image data processed through input 211 is stored in a buffer of DCT buffers 260, such as DCT coefficients buffers 265 or 266. Each of DCT coefficients buffers 265 and 266 hold a full block of image data for DCT processor 225.

DCT core 220 performs the DCT or IDCT processing on the image data stored in DCT buffers 269, such as first DCT coefficients buffer 265, received through input 211. As previously discussed, the image data may be 8-8 image data or 2-4-8 image data. 8-8 image data includes a single 8×8 block of image data to be processed. In comparison, 2-4-8 image data includes two related 4×8 sets of image data corresponding to separate fields of an interlaced image block.

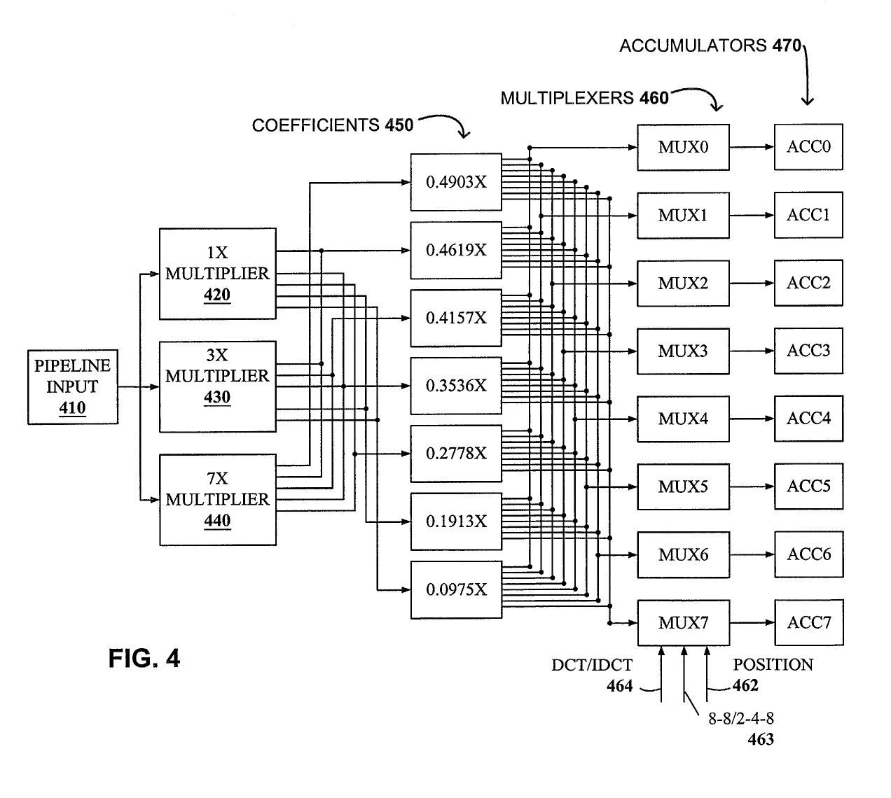

In one embodiment, the image data is 8-8 image data. The 8-8 image data is processed using an 8-8 DCT matrix 230. The 8-8 DCT matrix 230 includes values so that, when a block of 8-8 image data is multiplied by 8-8 DCT matrix 230, a one-dimensional DCT transformed result may be generated, as described further in reference to FIG. 4. In one embodiment, the one-dimensional result represents a set of first pass results. The same process is then repeated with a transpose performed on the first pass results to complete a two-dimensional DCT operation. In one embodiment, when the DCT processor 225 is instructed that an IDCT is to be performed on 8-8 image data passed from DCT reader 210, the 8-8 image data is multiplied by a transpose of 8-8 DCT matrix 230. In one embodiment, to transpose 8-8 DCT matrix 230, 8-8 DCT matrix 230 is accessed by table access component 226 using a column major scheme (column versus row) to perform an IDCT, while 8-8 matrix 230 is accessed by table access component 226 using a row major scheme (row versus column) for DCT operations.

In one embodiment, the image data is 2-4-8 image data. A 2-4-8 DCT matrix 240 is first applied to the 2-4-8 image data to generate a set of first pass results. The 8-8 DCT matrix 240 may then be applied to the first pass results to complete a two-dimensional IDCT or DCT operation. In one embodiment, DCT processor 225 is set, through input 211, to perform an FDCT on the 2-4-8 image data. Accordingly, a block of 2-4-8 image data is stored together as a matrix in a buffer of buffers 260, such as second DCT coefficients buffer 266. As previously discussed, 2-4-8 image data is constructed to include two 4×8 sets of data including information about fields of a block of video. A first 4×8 block includes a summation of the two fields. A second 4×8 block includes a difference between the two fields. The two 4×8 fields may be stored together as a full block of data. The matrix of the 2-4-8 image data stored in second DCT coefficients buffer 266 is multiplied by 2-4-8 DCT matrix 240, accessed through table access component 226, to generate transformed image data. In one embodiment, the 2-4-8 DCT matrix 240 is accessed row-major to perform an FDCT operation and is accessed column-major for IDCT operations. Instead of transposing the DCT matrices 230 and 240, values from DCT matrices 230 and 240 may be read in a vertical direction when processing with the DCT matrices 230 or 240, with results being written in a horizontal direction. In one embodiment, 2-4-8 image data is converted into 8-8 image data and then processed as 8-8 image data.

DCT core 220 includes DCT buffers 260 for storing image data before and after being processed. First and second DCT coefficients buffers 265 and 266 are used for storing blocks of image data for processing through DCT processor 225. First and second DCT result buffers 261 and 262 may be used for storing the results of processing performed on image data stored in first and second DCT coefficients buffers 265 and 266, respectively. A third DCT result buffer 263 may be used to provide additional storage during processing. In one embodiment, third DCT result buffer 263 is used to merge results from two processed blocks, such as from first and second DCT results buffers 261 and 262, for combining processed U-plane and V-plane data to generate a single UV-plane data set.

The DCT-processed (FDCT or IDCT) results from DCT results 261, 262 or 263 may be sent to DCT writer 270 for storage in memory. DCT writer 270 provides memory control to store the DCT-processed results in memory. DCT writer 270 makes appropriate memory requests from a memory controller (not shown) for storing the results. In one embodiment, buffers 260 are used to combine a first and second set of DCT-processed Y data, and a third and fourth set of DCT-processed Y-data prior to being sent to memory, allowing DCT writer 270 to utilize more memory bandwidth than sending each set of Y-data separately. In one embodiment, DCT component 122 is part of a single monolithic semiconductor device.

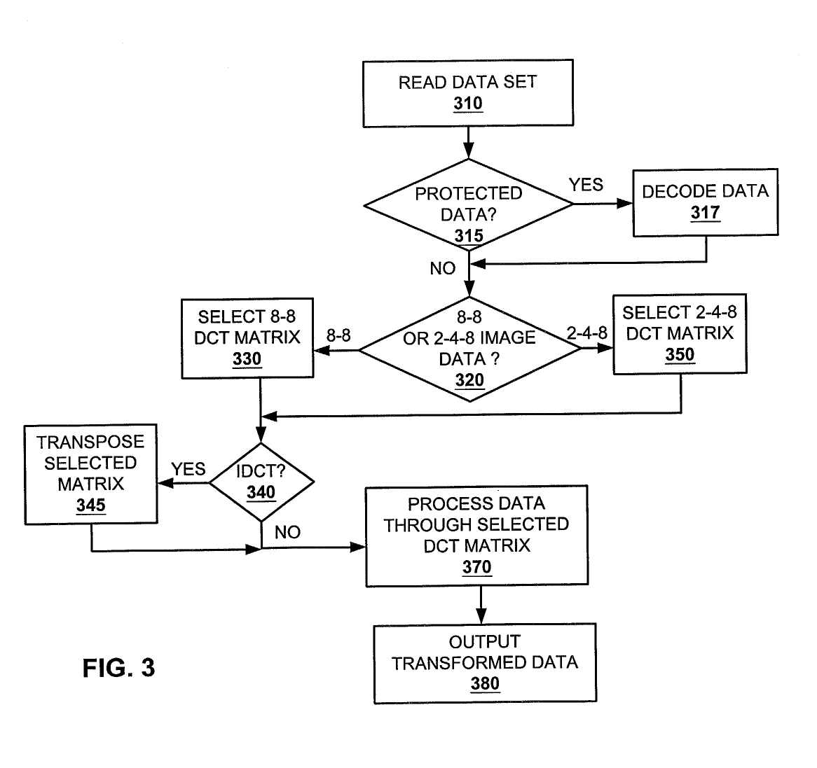

Referring now to FIG. 3, a flow diagram illustrating a method of handling the processing of multiple forms of image data is shown, according to one embodiment of the present invention. Image data is read and processed through a DCT matrix. A different DCT matrix is used for processing different types of image data. In one embodiment, the DCT matrix is transposed for IDCT operations.

In step 310, a DCT processing component, such as DCT component 122 (FIG. 2), reads a set of image data. In one embodiment, the image data set is read from memory. Memory requests are sent to a memory controller, including a specific memory address to access the image data from. In another embodiment, the image data set is read from an image data buffer. The image data may be located in hardware, such as graphics chip 120 (FIG. 1), or be provided by a software driver, such as from image data buffer 112 of software driver 110 (FIG. 1).

In step 315, it is determined if the data is protected. In one embodiment, image data corresponding to transformed image data is protected through encryption or another encoding process. If the image data is being read from the source, such as software driver 110, an encrypted link may be established using a dynamic encryption key. In step 315, if the image data is protected, the image data is decoded in step 317. If the image data is not encrypted, or once protected image data has been decoded through step 317, the DCT processing component continues at step 320.

In step 320, it is determined if the image data is related to 8-8 image data or 2-4-8 image data.

As previously discussed, 8-8 image data refers to an 8×8 block of image data relating to a full block of image data as a whole set. A 2-4-8 block of image data includes two separate 4×8 blocks of image data which are each generated using separate fields of a block of image data. A first 4×8 data set is associated with a summation of the two fields. A second 4×8 data set is associated with a difference between the two fields. In one embodiment, identifiers are attached with the image data to indicate whether the image data relates to 8-8 image data or 2-4-8 image data.

In step 320, if the image data is 8-8 image data, an 8-8 DCT matrix is selected for both passes in the two pass processing used to perform two-dimensional DCT calculations, as in step 330. Alternatively, if the image data is 2-4-8 image data, a 2-4-8 DCT matrix is selected for a first pass, as in step 250. In the case of 2-4-8 image data, the 8-8 DCT matrix would be selected to perform processing for a second pass. In one embodiment, the identifier included with the image data indicates whether the image data is related to 8-8 image data or 2-4-8 image data. in one embodiment, 2-4-8 image data is converted into 8-8 image data and then processed as 8-8 image data.

In step 340, it is determined if the image data is to be forward processed (FDCT) or inverse processed (IDCT). In step 340, if an FDCT is to be performed, the selected DCT matrix (from step 320) is left “as is” and the DCT processing component continues to step 370. In step 345, if an IDCT is to be performed, the selected DCT matrix is transposed, as in step 345. In one embodiment, the selected DCT matrix is read in a normal, row-major fashion for FDCT processing. To transpose the matrix for IDCT processing, the selected DCT matrix is read in a column-major fashion. Accordingly, step 345 may be used to simply apply an option to read, or index, the selected DCT matrix by columns versus rows. In one embodiment, values from the selected DCT matrix are read in a vertical direction with results being written in a horizontal direction.

In step 370, the image data is processed using the selected DCT matrix. The selected DCT matrix (transposed if an IDCT operation) is multiplied by a matrix composed of the image data. In step 380, the DCT processing component outputs the processed image data. In one embodiment, the processed image data is output to memory.

Referring now to FIG. 4, a block diagram illustrating a pipeline for calculating forward and inverse transforms on a set of image data using a single matrix structure is shown, according to one embodiment of the present invention. Image data is processed using DCT transforms (FDCT or IDCT). Received image data is related to either 8-8 image data or 2-4-8 image data. Either type of image data is used to construct an 8×8 matrix of image data. A DCT matrix is constructed so that a product of the DCT matrix and the image data matrix, results in an FDCT of the image data. To generate an IDCT of the image data, a transpose of the DCT matrix is used.

An FDCT may be constructed using an FDCT function, F(u,v). The two-dimensional FDCT represents a matrix of frequencies based on the input image data. In the function, F(u,v), “u” denotes frequency values of the image data in a horizontal direction and “v” represents frequency values of the image data in a vertical direction. A function f(x,y) may be used to represent the image data. In the function f(x,y), “x” represents a horizontal position and “y” represents a vertical position of a particular picture element. Alternatively, the function f(x,y) may represent an IDCT function performed on a transformed set of image data, F(u,v). The functions of F(u,v) and f(x,y) for 8-8 image data, F₈₋₈(u,v) and f₈₋₈(x,y), are shown in the following equations:

$$\begin{matrix}{F}_{8 \text{-} 8} ( h , v ) = C ( v ) C ( h ) {\sum }_{y = 0}^{7} {\sum }_{x = 0}^{7} cos ( \frac{π v ( 2 y + 1 )}{16} ) cos ( \frac{π h ( 2 x + 1 )}{16} ) f ( x , y ) \\ {f}_{8 \text{-} 8} ( x , y ) = {\sum }_{v = 0}^{7} {\sum }_{h = 0}^{7} C ( v ) C ( h ) cos ( \frac{π v ( 2 y + 1 )}{16} ) cos ( \frac{π h ( 2 x + 1 )}{16} ) F ( h , v )\end{matrix} where \begin{matrix}C ( h ) = 0.5 / \sqrt{2} for h = 0 \\ C ( h ) = 0.5 for h > 0 \\ C ( v ) = 0.5 / \sqrt{2} for v = 0 \\ C ( v ) = 0.5 for v > 0 \end{matrix}$$

In one embodiment, weighting values are applied to each of the values of the result of F(u,v). For 8-8 image data, the results of F₈₋₈(u,v) are multiplied by the weighted values of w₈₋₈(u,v) using values as follows:

$$\begin{matrix}{w}_{8 \text{-} 8} ( 0 , 0 ) = \frac{1}{4} \\ {w}_{8 \text{-} 8} ( h , v ) = \frac{w ( h ) w ( v )}{2}\end{matrix} where \begin{matrix}w ( 0 ) = 1 & w ( 4 ) = \frac{7}{8} \\ w ( 1 ) = \frac{cos ( 4 π / 16 )}{4 cos ( 2 π / 16 ) cos ( 7 π / 16 )} & w ( 5 ) = \frac{cos ( 4 π / 16 )}{cos ( 3 π / 16 )} \\ w ( 2 ) = \frac{cos ( 4 π / 16 )}{2 cos ( 6 π / 16 )} & w ( 6 ) = \frac{cos ( 4 π / 16 )}{cos ( 2 π / 16 )} \\ w ( 3 ) = \frac{1}{2 cos ( 5 π / 16 )} & w ( 7 ) = \frac{cos ( 4 π / 16 )}{cos ( π / 16 )}\end{matrix}$$

Similarly, the functions of F(u,v) and f(x,y) for 2-4-8 image data, F₂₋₄₋₈(u,v) and f₂₋₄₋₈(x,y), are shown in the following equations, where “z” denotes y/2, for indexing image data between alternating fields:

$$\begin{matrix}{F}_{2 \text{-} 4 \text{-} 8} ( h , v ) = C ( v ) C ( h ) {\sum }_{z = 0}^{3} {\sum }_{x = 0}^{7} cos ( \frac{π v ( 2 z + 1 )}{8} ) cos ( \frac{π h ( 2 x + 1 )}{16} ) ( f ( x , 2 z ) ⊕ f ( x , 2 z + 1 ) ) \\ {f}_{2 \text{-} 4 \text{-} 8} ( x , y ) = {\sum }_{v = 0}^{3} {\sum }_{h = 0}^{7} C ( v ) C ( h ) cos ( \frac{π v ( 2 z + 1 )}{8} ) cos ( \frac{π h ( 2 x + 1 )}{16} ) ( F ( h , v ) ⊗ F ( h , v + 4 ) )\end{matrix} where \begin{matrix}⊕ is + for v < 4 \\ ⊕ is - for v > 3 \\ ⊗ is - for odd y \\ ⊗ is + for even y \end{matrix}$$

If the DCT coefficients F₂₋₄₋₈(uv) are weighted, the DCT coefficients are weighted differently (compared with standard DCT):

$$\begin{matrix}{w}_{2 \text{-} 4 \text{-} 8} ( 0 , 0 ) = \frac{1}{4} \\ {w}_{2 \text{-} 4 \text{-} 8} ( h , v ) = \frac{w ( h ) w ( 2 v )}{2} for v < 4 \\ {w}_{2 \text{-} 4 \text{-} 8} ( h , v ) = \frac{w ( h ) w ( 2 ( v - 4 ) )}{2} for v \geq 4\end{matrix}$$

In one embodiment, the functions of the FDCT are compressed by quantizing the values. A table of quantization values is used to limit the range and size of the results. For an IDCT, the values must be de-quantized prior to applying the IDCT. In one embodiment, the DCT functions, F(u,v) for FDCT and f(x,y) for IDCT, are applied using a DCT matrix. In one embodiment, a one-dimensional 8-8 DCT matrix for FDCT operations on 8-8 image data is as shown in Table 1.

TABLE 1
DCT matrix for 8-8 image data

| | U = 0 | U = 1 | U = 2 | U = 3 | U = 4 | U = 5 | U = 6 | U = 7 |
|---|---|---|---|---|---|---|---|---|
| X = 0 | 0.35355339 | 0.49039264 | 0.46193977 | 0.41573481 | 0.35355339 | 0.27778512 | 0.19134172 | 0.09754516 |
| X = 1 | 0.35355339 | 0.41573481 | 0.19134172 | −0.09754516 | −0.35355339 | −0.49039264 | −0.46193977 | −0.27778512 |
| X = 2 | 0.35355339 | 0.27778512 | −0.19134172 | −0.49039264 | −0.35355339 | 0.09754516 | 0.46193977 | 0.41573481 |
| X = 3 | 0.35355339 | 0.09754516 | −0.46193977 | −0.27778512 | 0.35355339 | 0.41573481 | −0.19134172 | −0.49039264 |
| X = 4 | 0.35355339 | −0.09754516 | −0.46193977 | 0.27778512 | 0.35355339 | −0.41573481 | −0.19134172 | 0.49039264 |
| X = 5 | 0.35355339 | −0.27778512 | −0.19134172 | 0.49039264 | −0.35355339 | −0.09754516 | 0.46193977 | −0.41573481 |
| X = 6 | 0.35355339 | −0.41573481 | 0.19134172 | 0.09754516 | −0.35355339 | 0.49039264 | −0.46193977 | 0.27778512 |
| X = 7 | 0.35355339 | −0.49039264 | 0.46193977 | −0.41573481 | 0.35355339 | −0.27778512 | 0.19134172 | −0.09754516 |

The DCT matrix is multiplied by the 8-8 image data to generate one-dimensional FDCT results. It should be noted the DCT matrix of Table 1 may also be used to generate IDCT results through a transpose of the DCT matrix of Table 1. The transposed DCT matrix is then multiplied by the image data. Similarly, a DCT matrix may be constructed for processing 2-4-8 image data. An example of a DCT matrix for 2-4-8 data is shown in Table 2.

TABLE 2
DCT matrix for 2-4-8 image data

| | U = 0 | U = 1 | U = 2 | U = 3 | U = 4 | U = 5 | U = 6 | U = 7 |
|---|---|---|---|---|---|---|---|---|
| X = 0 | 0.35355339 | 0.46193977 | 0.35355339 | 0.19134172 | 0.35355339 | 0.46193977 | 0.35355339 | 0.19134172 |
| X = 1 | 0.35355339 | 0.46193977 | 0.35355339 | 0.19134172 | −0.35355339 | −0.46193977 | −0.35355339 | −0.19134172 |
| X = 2 | 0.35355339 | 0.19134172 | −0.35355339 | −0.46193977 | 0.35355339 | 0.19134172 | −0.35355339 | −0.46193977 |
| X = 3 | 0.35355339 | 0.19134172 | −0.35355339 | −0.46193977 | −0.35355339 | −0.19134172 | 0.35355339 | 0.46193977 |
| X = 4 | 0.35355339 | −0.19134172 | −0.35355339 | 0.46193977 | 0.35355339 | −0.19134172 | −0.35355339 | 0.46193977 |
| X = 5 | 0.35355339 | −0.19134172 | −0.35355339 | 0.46193977 | −0.35355339 | 0.19134172 | 0.35355339 | −0.46193977 |
| X = 6 | 0.35355339 | −0.46193977 | 0.35355339 | −0.19134172 | 0.35355339 | −0.46193977 | 0.35355339 | −0.19134172 |
| X = 7 | 0.35355339 | −0.46193977 | 0.35355339 | −0.19134172 | −0.35355339 | 0.46193977 | −0.35355339 | 0.19134172 |

The DCT matrix of Table 2, for 2-4-8 image data, is applied on an 8×8 block consisting of 2-4-8 image data through matrix multiplication, as discussed for 8-8 image data and the DCT matrix of Table 1. Similarly, the DCT matrix of Table 2 is transposed to perform IDCT operations on the 2-4-8 image data. As can be seen in Tables 1 and 2, common sets of coefficients are used in both DCT matrices. As shown in Table 3, each of the coefficient values may be approximated through a summation of three integer-based fractions.

TABLE 3
DCT Coefficient Approximations

| | 1st | 2nd | 3rd | Error |
|---|---|---|---|---|
| 0.49039264 | 7/16 | 7/128 | −7/4096 | 0.000085875 |
| 0.46193977 | 7/16 | 3/128 | 1/1024 | −0.000025704 |
| 0.41573481 | 7/16 | −3/128 | 7/4096 | 0.000036678 |
| 0.35355339 | 1/4 | 7/64 | −3/512 | −0.000037766 |
| 0.27778512 | 1/4 | 7/256 | 7/16384 | −0.000014120 |
| 0.19134172 | 3/16 | 1/256 | −1/16384 | 0.000003499 |
| 0.09754516 | 3/32 | 1/256 | −1/8192 | −0.000010981 |

Using the approximations of Table 3, the DCT matrices of Tables 1 and 2 may be applied to respective 8-8 and 2-4-8 image data blocks through a four-stage pipeline, as shown in FIG. 4. A pipeline input 410 is used to input the image data values into the matrices. A 1× multiplier 420 is used for the numerator in the approximations shown in Table 3, such as the ¼ approximation listed in the 1^{st} column. The 3× multiplier 430 and 7× multiplier 440 are also used for fractions involving a numerator of ‘3’ and ‘7’, respectively. The multipliers 420, 430 and 440 are used to generate the coefficients 450.

Multiplexers 460 may be used to select individual values from coefficients 450. Each value of an image data matrix is input through pipeline input 410 and multiplied by a selected coefficient of coefficients 450. The coefficient is selected using a POSITION signal 462, indicating a current position in the image data matrix. A counter (not shown) may be used to clock in image data values into pipeline input 410 and update the current value of POSITION signal 462. A DCT/IDCT signal 464 also is used to select between row-maj or and column-major interpretations of the DCT matrices. An 8-8/2-4-8 signal 463 is used to select a type of DCT matrix needed for the current operations, such as selecting among an 8-8 matrix or a 2-4-8 DCT matrix. In one embodiment, accumulators 470 are used to combine the products of the coefficients 450 and the image data values. In one embodiment, an image data value is clocked into pipeline input 410 for every clock pulse; however, the corresponding results of the DCT operation (FDCT r IDCT) are only finalized in accumulators 470 after every eighth clock pulses. It should be noted that accumulators 470 combine previous product values as are combined in general matrix product operations. In one embodiment, the system of FIG. 4 is processed through software. Alternatively, the system of FIG. 4 may be processed through hardware.

The systems described herein may be part of an information handling system. The term “information handling system” refers to any system that is capable of processing information or transferring information from one source to another. An information handling system may be a single device, such as a computer, a personal digital assistant (PDA), a hand held computing device, a cable set-top box, an Internet capable device, such as a cellular phone, and the like. Alternatively, an information handling system may refer to a collection of such devices. It should be appreciated that while components of the system have been describes in reference to video and audio processing components, the present invention may be practiced using other types of system components. It should be appreciated that the system described herein has the advantage of providing FDCT and IDCT operations for both 8-8 and 2-4-8 image data sets.

In the preceding detailed description of the embodiments, reference has been made to the accompanying drawings which form a part thereof, and in which is shown by way of illustration specific embodiments in which the invention maybe practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising the steps of:
receiving first data associated with a block of data at a video processor;
when in a first mode of operation, accessing table data in a table in a first manner to perform a first transform of the first data; and
when in a second mode of operation, accessing table data in the table in a second manner to perform a second transform of the first data, wherein the second transform is an inverse transform relative to the first transform.

2. The method as in claim 1, wherein the block of video data is associated with 8×8 image data.

3. The method as in claim 1, wherein the block of video data is associated with 2-4-8 image data.

4. The method as in claim 1, further including the step of determining one of the first mode of operation or the second mode of operation based on a tag associated with the first data, wherein the tag identifies a transform associated with the first data.

5. The method as in claim 1, wherein accessing in a first manner includes accessing the table data in the table in a row-major scheme and accessing in a second manner includes accessing the table data in the table in a column-major scheme.

6. The method as in claim 1, wherein the table includes a discrete cosine transform matrix.

7. The method as in claim 6, wherein the first transform includes a forward discrete cosine transform and the second transform includes an inverse discrete cosine transform.

8. The method as in claim 1, wherein the first and second transform are performed using common hardware.

9. A method comprising the steps of:
receiving data associated with a block of data at a video processor;
when the block of data is of a first type, providing a first table to a transform engine to transform the data; and
when the block of data is of a second type, providing a second table to the transform engine to transform the data.

10. The method as in claim 9, further including the steps of:
when in a first mode of operation, accessing one of the first table or the second table in a first manner to perform a first transform; and
when in a second mode of operation, accessing one of the first table or the second table in a second manner to perform a second transform, wherein the second transform is an inverse transform relative to the first transform.

11. The method as in claim 10, wherein accessing in a first manner includes accessing one of the first table or the second table using a row-major scheme and accessing in a second manner includes accessing one of the first table or the second table using a column-major scheme.

12. The method as in claim 9, further including the step of determining the type of data.

13. The method as in claim 12, wherein motion estimation is performed to determine the type of data.

14. The method as in claim 12, wherein a tag associated with the block of data is used to determine the type of data.

15. The method as in claim 9, wherein the first type includes 8-8 image data and the second type includes 2-4-8 image data.

16. The method as in claim 9, wherein the first table includes a first DCT matrix associated with the first type and the second table includes a second DCT matrix associated with the second type.

17. A method comprising the steps of:
receiving data associated with a block of data at a video processor;
providing a first table to a transform engine to generate a first transform of the data;
providing a second table to the transform engine to generate a second transform of the data; and
selecting one of the first transform or the second transform dependent on a comparison of values associated with the first transform and the second transform.

18. The method as in claim 17, wherein the comparison includes identifying one of the first transform or the second transform associated with smaller values.

19. A system comprising:
a reader to access data associated with a block of data;
a transform engine to transform the data according to a table;
a table access component to:
access said table in a first manner to perform a first transform;
access said table in a second manner to perform a second transform, wherein the second transform is an inverse transform relative to the first transform; and
a memory to store said data, said table, and a result from one of said first transform or said second transform.

20. The system as in claim 19, wherein said block of data is associated with one of 8-8 image data or 2-4-8 image data.

21. The system as in claim 19, wherein said reader includes an input port to determine one of said first manner or said second manner to access said table.

22. The system as in claim 21, wherein said first manner includes accessing said table in a row-major scheme and said second manner includes accessing said table in a column-major scheme.

23. The system as in claim 19, wherein said table includes a discrete cosine transform matrix and further wherein said first transform includes a forward discrete cosine transform and said second transform includes an inverse discrete cosine transform.

24. A system comprising:
a reader to access data associated with a block of data, said reader to:
provide a first table to a transform engine, when the block of data is of a first type;
provide a second table to said transform engine, when the block of data is of a second type;
said transform engine to transform said data using one of said first table or said second table; and
a memory to store said data, said first table, said second table and a transform result from said transform engine.

25. The system as in claim 24, wherein the first type is 8-8 image data and the second type is 2-4-8 image data.

26. The system as in claim 24, wherein said reader determines a type of data dependent on a tag associated with the block of data.

27. The system as in claim 24, wherein said first table includes a discrete cosine transform associated with the first type and the said second table includes a discrete cosine transform associated with the second type.
